(19) United States
(12) Patent Application Publication
(10) Pub. No.: US 2023/0325661 A1
(43) Pub. Date: Oct. 12, 2023

(54) LEARNING METHOD, CLUSTERING METHOD, LEARNING APPARATUS, CLUSTERING APPARATUS AND PROGRAM

(71) Applicant: NIPPON TELEGRAPH AND TELEPHONE CORPORATION, Tokyo (JP)

(72) Inventor: Tomoharu IWATA, Tokyo (JP)

(21) Appl. No.: 18/043,166

(22) PCT Filed: Sep. 18, 2020
(86) PCT No.: PCT/JP2020/035549

§ 371 Date: Feb. 27, 2023

(51) Int. Cl. G06N 3/08

(52) U.S. Cl. CPC G06N 3/08

(57) ABSTRACT

A learning method, executed by a computer including a memory and a processor, includes: inputting a plurality of items of data, and a plurality of labels representing clusters to which the plurality of items of data belong; converting each of the plurality of items of data by a predetermined neural network, to generate a plurality of items of representation data; clustering the plurality of items of representation data; calculating a predetermined evaluation scale indicating performance of the clustering, based on the clustering result and the plurality of labels; and learning a parameter of the neural network, based on the evaluation scale.

### TECHNICAL FIELD

The present invention relates to a learning method, a clustering method, a learning apparatus, a clustering apparatus and a program.

### BACKGROUND ART

Clustering is a method of dividing a plurality of items of data into clusters such that items of data similar to one another form the same cluster. A clustering method is known in which items of data are clustered while automatically determining the number of clusters by an infinite Gaussian mixture model (for example, see Non Patent Literature 1).

### CITATION LIST

### Non Patent Literature

Non Patent Literature 1: Rasmussen, Carl Edward. The infinite Gaussian mixture model. Advances in Neural Information Processing Systems. 2000.

### SUMMARY OF INVENTION

### Technical Problem

However, in the above conventional method, clustering performance may be deteriorated for complex data (that is, data for which clusters cannot be represented by a Gaussian distribution).

One embodiment of the present invention is devised in view of the above, and has an object to implement high-performance clustering.

### Solution to Problem

For achieving the object stated above, a learning method according to one embodiment is executed by a computer, the method including: an input procedure of inputting a plurality of items of data, and a plurality of labels representing clusters to which the plurality of items of data belong; a representation generation procedure of converting each of the plurality of items of data by a predetermined neural network, to generate a plurality of items of representation data; a clustering procedure of clustering the plurality of items of representation data; a calculation procedure of calculating a predetermined evaluation scale indicating performance of the clustering, based on the clustering result and the plurality of labels; and a learning procedure of learning a parameter of the neural network, based on the evaluation scale.

### Advantageous Effects of Invention

High-performance clustering can be implemented.

### BRIEF DESCRIPTION OF DRAWINGS

FIG. 1 This is a diagram illustrating one example of a functional configuration of a clustering apparatus according to a present embodiment.

FIG. 2 This is a flowchart illustrating one example of a flow of learning processing according to the present embodiment.

FIG. 3 This is a flowchart illustrating one example of a flow of test processing according to the present embodiment.

FIG. 4 This is a diagram illustrating one example of a hardware configuration of a clustering apparatus according to the present embodiment.

### DESCRIPTION OF EMBODIMENTS

Hereinafter, one embodiment of the present invention will be described. In the present embodiment, a clustering apparatus 10 capable of implementing high-performance clustering even for complicated data will be described. The clustering apparatus 10 according to the present embodiment operates in a learning period and a testing period; when operating in the learning period, a labeled data set is given and a parameter for training is learned from this labeled data set (that is, the labeled data set is a training data set). On the other hand, when operating in the testing period, unlabeled data to be clustered is given and the unlabeled data is clustered using the learned parameter. The label is information indicating a cluster to which data belongs (that is, a true cluster or a correct cluster). Note that the clustering apparatus 10 may be referred to as, for example, a “learning apparatus” when operating in the learning period.

Hereinafter, it is assumed that, when the clustering apparatus 10 operates in the learning period, a data set of C clusters is given as input data.

{X_{c}}_{c=1}^{C} [Math. 1]

where X_{c}={x_{cn}} is a data set of a cluster c, and x_{cn}, is an n-th item of data belonging to the cluster c. Note that x_{cn} is data (hereinafter sometimes referred to as “case data”) indicating a case of a target task (for example, observed values of a sensor).

On the other hand, it is assumed that data {xₙ} in the target task is given as input data when the clustering apparatus 10 operates in the testing period. Similarly, xₙ is case data of the target task. A case data set {xₙ} in the target task is data to be clustered, and it is an object to cluster this data with high performance. Note that the performance of clustering is evaluated by a clustering evaluation scale (for example, an adjusted Rand index to be described later).

<Functional Configuration>

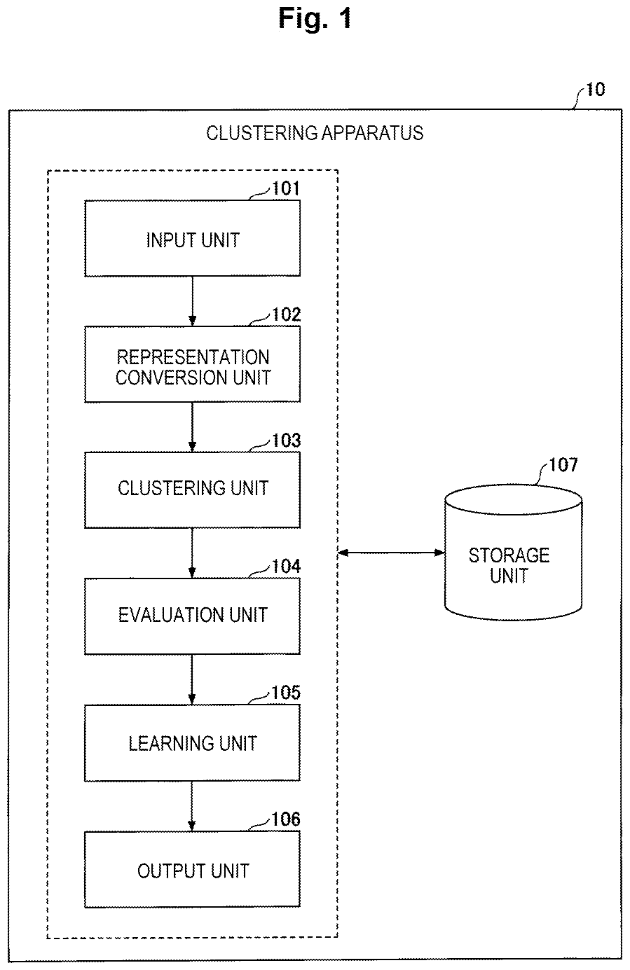

A functional configuration of the clustering apparatus 10 according to the present embodiment will be described with reference to FIG. 1. FIG. 1 is a diagram illustrating one example of a functional configuration of the clustering apparatus 10 according to the present embodiment.

As illustrated in FIG. 1, the clustering apparatus 10 according to the present embodiment includes an input unit 101, a representation conversion unit 102, a clustering unit 103, an evaluation unit 104, a learning unit 105, an output unit 106, and a storage unit 107.

The storage unit 107 stores various data used when the clustering apparatus 10 operates in the learning period or in the testing period. That is, the storage unit 107 stores at least a labeled data set {X_{c}} for training when operating in the learning period. In addition, the storage unit 107 stores at least unlabeled data {xₙ} to be clustered and a learned parameter when operating in the testing period.

When operating in the learning period, the input unit 101 inputs the labeled data set {X_{c}} for training from the storage unit 107 as input data. In addition, when operating in the testing period, the input unit 101 inputs the unlabeled data {xₙ} to be clustered from the storage unit 107 as input data.

The representation conversion unit 102 generates a representation vector representing a feature of each item of case data when operating in the learning period and in the testing period. The representation conversion unit 102 generates a representation vector zₙ by converting the case data xₙ by a neural network. That is, the representation conversion unit 102 calculates the representation vector zₙ from the case data xₙ by, for example, the following Formula (1):

[Math. 2]

zₙ=f(xₙ) (1)

where f denotes a neural network. A parameter 9 of the neural network is a parameter to be learned when operating in the learning period. Therefore, the learned parameter 9 is used when operating in the testing period.

As the neural network f stated above, any type of neural network can be used according to data. For example, a feedforward neural network, a convolutional neural network, a recursive neural network, or the like may be used.

Note that in a case where data representing a target task representation is given, the target task representation data may be added to the input of the neural network. In addition, the target task representation data may be learned from the labeled data set for training and added to the input of the neural network.

The clustering unit 103 clusters a set of the representation vectors generated by the representation conversion unit 102 when operating in the learning period and in the testing period. Hereinafter, a case will be described where a set of representation vectors {z₁, . . . , z_{N}} is clustered by estimating an infinite mixture Gaussian distribution by a variational Bayesian method with the number of elements in the set of representation vectors being N (that is, the number of items of the case data x; to be converted by the representation conversion unit 102 is also N). However, the clustering method is not limited to estimating the infinite mixture Gaussian distribution by the variational Bayesian method, and other methods may be used, for example, soft clustering by a differentiable calculation procedure such as estimating a mixture Gaussian distribution by an expectation maximization (EM).

The clustering unit 103 can cluster the set of representation vectors {z₁, . . . , z_{N}} by the following steps S1 to S4:

S1) The clustering unit 103 initializes a contribution rate of each item of case data as follows:

R={{rₙₖ}ₖ₌₁^{K′}}ₙ₌₁^{N} [Math. 3]

where rₙₖ is a probability that an n-th item of case data belongs to a k-th cluster, and K′ is the maximum number of clusters set in advance. Note that the contribution rate R may be initialized randomly, or may be initialized using a neural network receiving a representation vector as input.

S2) The clustering unit 103 initializes parameters as follows:

a={aₖ}ₖ₌₁^{K′}, b={bₖ}ₖ₌₁^{K′} [Math. 4]

S3) The clustering unit 103 repeats updating the following parameters:

{γₖ₁}ₖ₌₁^{K′},{γₖ₂}ₖ₌₁^{K′},{μₖ}ₖ₌₁^{K′},a,b [Math. 5]

and the contribution rate R for n=1, . . . , N until a predetermined first end condition is satisfied. At this time, the clustering unit 103 updates parameters γₖ₁, γₖ₂, μₖ, aₖ, and bₖ for k=1, . . . , and K′ by following Formulas (2) to (6).

$$\begin{matrix}[ Math . 6 ] & \\ {γ}_{k 1} = 1 + {\sum }_{n = 1}^{N} {r}_{nk} & ( 2 )\end{matrix}$$

$${γ}_{k 2} = α + {\sum }_{n = 1}^{N} {\sum }_{{k}^{′} = k + 1}^{{K}^{′}} {r}_{{nk}^{′}} \qquad ( 3 )$$

$${μ}_{k} = \frac{\frac{{b}_{k}}{{a}_{k}} {\sum }_{n = 1}^{N} {r}_{nk} {z}_{n}}{1 + \frac{{b}_{k}}{{a}_{k}} {\sum }_{n = 1}^{N} {r}_{nk}} \qquad ( 4 )$$

$${a}_{k} = 1 + \frac{S}{2} {\sum }_{n = 1}^{N} {r}_{nk} \qquad ( 5 )$$

$${b}_{k} = 1 + {\sum }_{n = 1}^{N} {r}_{nk} ( {‖ {x}_{n} - {μ}_{k} ‖}^{2} + S ) \qquad ( 6 )$$

where α is a hyperparameter, and S is the dimensionality of the representation vector. The isotropic Gaussian distribution is assumed herein for each cluster, but a Gaussian distribution having an any covariance matrix can also be assumed.

On the other hand, the clustering unit 103 updates the contribution rate R for k=1, . . . , and K′ by the following Formula (7):

$$\begin{matrix}[ Math . 7 ] & \\ log {r}_{nk} ∝ Ψ ( {γ}_{k 1} ) - Ψ ( {γ}_{k 1} + {γ}_{k 2} ) - \frac{S}{2} ( Ψ ( {a}_{k} ) - log ( {b}_{k} ) ) - \frac{{a}_{k}}{2 {b}_{k}} ( {‖ {z}_{n} - {μ}_{k} ‖}^{2} + S ) + {\sum }_{{k}^{′} = k + 1}^{{K}^{′}} ( Ψ ( {γ}_{k 2} ) - Ψ ( {γ}_{k 1} + {γ}_{k 2} ) ) & ( 7 )\end{matrix}$$

where Ψ is a digamma function.

S4) Then, in a case where the predetermined first end condition is satisfied, the clustering unit 103 outputs the contribution rate R as the clustering result. Note that examples of the first end condition stated above include a condition that the number of repetitions of the updates exceeds a predetermined first threshold; a condition that the amount of change in the parameter or the contribution rate before and after the update is less than or equal to a predetermined second threshold; and the like.

When operating in the learning period, the evaluation unit 104 calculates a clustering evaluation scale indicating clustering performance of the contribution rate R on the basis of the contribution rate R output from the clustering unit 103 and a true cluster indicated by a label assigned to the input data (X_{c}) input by the input unit 101. Hereinafter, a case where an adjusted Rand index is calculated as the clustering evaluation scale will be described. However, the clustering evaluation scale is not limited to the adjusted Rand index, and for example, any clustering evaluation scale such as a Rand index can be adopted.

The adjusted Rand index for the contribution rate R output from the clustering unit 103 and the true cluster of the input data {X_{c}} input by the input unit 101 can be calculated by the following Formula (8):

$$\begin{matrix}[ Math . 8 ] & \\ ARI ( y , R ) = \frac{2 ( {U}_{1} {U}_{4} - {U}_{2} {U}_{3} )}{( {U}_{1} + {U}_{2} ) ( {U}_{3} + {U}_{4} ) + ( {U}_{1} + {U}_{3} ) ( {U}_{2} + {U}_{4} )} where & ( 8 )\end{matrix}$$

$$\begin{matrix}[ Math . 9 ] & \\ y = {\{ {y}_{n} \}}_{n = 1}^{N} & \end{matrix}$$

is a true cluster, and yₙ denotes a cluster to which the n-th item of case data belongs.

In addition, U₁ is calculated by the following Formula (9) which denotes an expected value of the number of pairs having different estimated clusters among pairs of case data items having different true clusters.

$$\begin{matrix}[ Math . 10 ] & \\ {U}_{1} = {\sum }_{n = 1}^{N} {\sum }_{{n}^{′} = n + 1}^{N} I ( {y}_{n} \neq {y}_{{n}^{′}} ) {d}_{{nn}^{′}} & ( 9 )\end{matrix}$$

U₂ is calculated by the following Formula (10) which denotes an expected value of the number of pairs of case data items having the same estimated cluster among pairs of case data items having different true clusters.

$$\begin{matrix}[ Math . 11 ] & \\ {U}_{2} = {\sum }_{n = 1}^{N} {\sum }_{{n}^{′} = n + 1}^{N} I ( {y}_{n} \neq {y}_{{n}^{′}} ) ( 1 - {d}_{{nn}^{′}} ) & ( 10 )\end{matrix}$$

U₃ is calculated by the following Formula (11) which denotes an expected value of the number of pairs having different estimated clusters among pairs of case data items having the same cluster.

$$\begin{matrix}[ Math . 12 ] & \\ {U}_{3} = {\sum }_{n = 1}^{N} {\sum }_{{n}^{′} = n + 1}^{N} I ( {y}_{n} = {y}_{{n}^{′}} ) {d}_{{nn}^{′}} & ( 11 )\end{matrix}$$

U₄ is calculated by the following Formula (12) which denotes an expected value of the number of pairs having the same estimated cluster among pairs of case data items having the same true cluster.

$$\begin{matrix}[ Math . 13 ] & \\ {U}_{4} = {\sum }_{n = 1}^{N} {\sum }_{{n}^{′} = n + 1}^{N} I ( {y}_{n} = {y}_{{n}^{′}} ) ( 1 - {d}_{{nn}^{′}} ) & ( 12 )\end{matrix}$$

Further, d_{nn′} in Formulas (9) to (12) stated above denotes a distance between the contribution rate of the n-th item of case data and the contribution rate of the n′-th item of case data, and for example, a total variation distance between probabilities shown in the following Formula (13) can be used.

$$\begin{matrix}[ Math . 14 ] & \\ {d}_{{nn}^{′}} = \frac{1}{2} \vert {r}_{nk} - {r}_{{n}^{′} k} \vert & ( 13 )\end{matrix}$$

However, instead of the distance, a probability that the n-th item of case data and the n′-th item of case data belong to different clusters may be used as d_{nn′} as follows:

$$\begin{matrix}[ Math . 15 ] & \\ {d}_{{nn}^{′}} = 1 - {\sum }_{k = 1}^{{K}^{′}} {r}_{nk} {r}_{{n}^{′} k} & \end{matrix}$$

Note that I (⋅) in Formulas (9) to (12) stated above is an indicator function, which is a function that takes 1 when I(true) and 0 when I(false).

When operating in the learning period, the learning unit 105 learns the parameter 6 of the neural network f such that the clustering performance is improved, by using the input data {X_{c}} input by the input unit 101.

For example, in a case where the adjusted Rand index is used as the clustering evaluation scale, the learning unit 105 learns the parameter 8 of the neural network f such that the adjusted Rand index becomes higher when the data is randomly generated. That is, the learning unit 105 learns the parameter 6 of the neural network f by the following Formula (14):

$$\begin{matrix}[ Math . 16 ] & \\ \hat{Θ} = arg {max}_{Θ} {𝔼}_{t} [ {𝔼}_{D ( t )} [ ARI ( y ( X ( t ) ) , R ) ] ] & ( 14 )\end{matrix}$$

where E denotes an expected value, t denotes a set of randomly generated classes, X(t) denotes a set of data belonging to the class included in t, and y(X(t)) denotes a true cluster of the data set X(t). Note that in the text of the description, a hat “\hat{ }” which should be written directly above Θ is written on the left side of Θ for convenience, to be written as “\hat{ }Θ”.

The output unit 106 outputs the learned parameter \hat{ }Θ learned by the learning unit 105 when operating in the learning period. In addition, the output unit 106 outputs the clustering result of the clustering unit 103 when operating in the testing period. An output destination of the output unit 106 may be any predetermined output destination, and for example, the storage unit 107 and a display may be considered.

Note that the functional configuration of the clustering apparatus 10 illustrated in FIG. 1 corresponds to a functional configuration for both the learning period and the testing period. For example, the clustering apparatus 10 when operating in the testing period may not include the evaluation unit 104 and the learning unit 105.

In addition, the clustering apparatus 10 when operating in the learning period and the clustering apparatus 10 when operating in the testing period may be implemented by different devices or apparatuses. For example, a first device and a second device may be connected via a communication network, in which the clustering apparatus 10 when operating in the learning period may be implemented by the first device, and the clustering apparatus 10 when operating in the testing period may be implemented by the second device.

<Flow of Learning Processing>

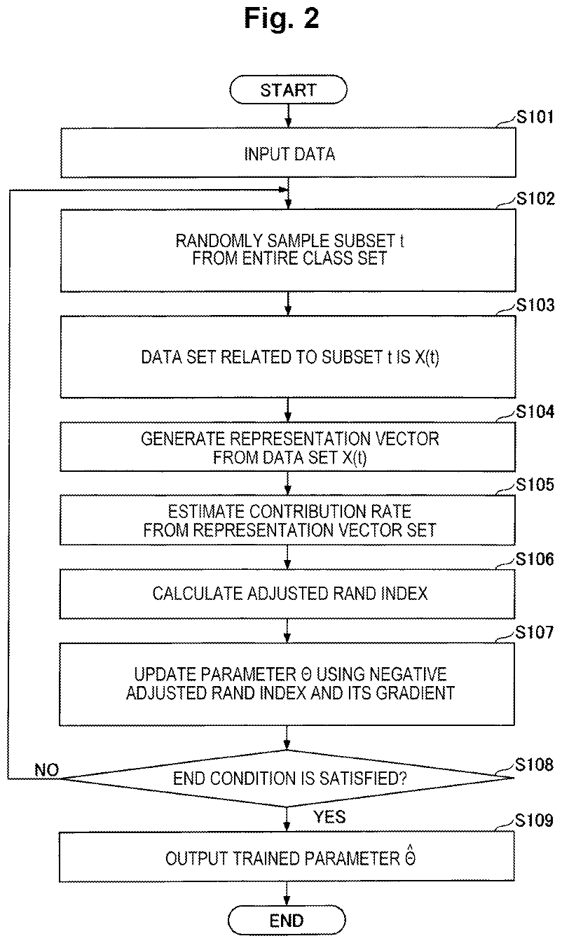

A flow of learning processing according to the present embodiment will be described with reference to FIG. 2 hereinbelow. FIG. 2 is a flowchart illustrating one example of the flow of the learning processing according to the present embodiment. Note that the parameter 9 of the neural network is assumed to have been initialized by a known method.

First, the input unit 101 inputs the labeled data set (X_{c}) (where c=1, . . . , C) for training from the storage unit 107 as input data (step S101).

The input unit 101 randomly samples a subset t from an entire class set {1, . . . , C} (step S102). Note that as described above, X_{c}={x_{cn}}.

Next, the input unit 101 sets a data set related to the subset t sampled in step S102 stated above as X(t) (step S103). That is, the input unit 101 sets the data set belonging to a class included in the subset t among the labeled data set {X_{c}} input in step S101 stated above as X(t). For the sake of simplicity, the number of items of case data included in X(t) is set to N, and X(t)={xₙ, yₙ} (n=1, . . . , N) hereinbelow. Note that yₙ is a label (information indicating a true cluster) of case data xₙ.

Next, the representation conversion unit 102 generates a representation vector zₙ from the case data xₙ included in the data set X(t) (step S104). Note that the representation conversion unit 102 may generate the representation vector zₙ by converting the case data xₙ using Formula (1) stated above.

Next, the clustering unit 103 clusters the set of representation vectors {z₁, . . . , z_{N}} generated in step S104 stated above, and estimates the contribution rate R as the clustering result (step S105). Note that the clustering unit 103 may perform clustering and estimation of the contribution rate R by steps S1 to S4 stated above.

Next, the evaluation unit 104 calculates the adjusted Rand index from the contribution rate R estimated and output in step S105 stated above and the label {y₁, . . . , y_{N}} included in the data set X(t) (step S106). Note that the evaluation unit 104 may calculate the adjusted Rand index by Formula (8) stated above.

Next, the learning unit 105 learns the parameter 9 of the neural network f by a known optimization method such as gradient descent using a negative adjusted Rand index and its gradient (step S107). Note that the adjusted Rand index is set to a negative number because it is necessary to treat a maximization problem as a minimization problem, to find an optimal solution by, for example, gradient descent.

The learning unit 105 determines whether a predetermined second end condition is satisfied (step S108). Note that examples of the second end condition stated above include a condition that the number of repetitions of the processing in steps S102 to S107 stated above exceeds a predetermined third threshold; a condition that the amount of change in the parameter 8 before and after the repetition is less than or equal to a predetermined fourth threshold; and the like.

In a case where it is determined that the predetermined second end condition is not satisfied in step S108 stated above, the clustering apparatus 10 returns to step S102 stated above. Accordingly, steps S102 to S107 stated above are repeatedly executed until the second end condition is satisfied.

On the other hand, in a case where it is determined that the predetermined second end condition is satisfied in step S108 stated above, the output unit 106 outputs the learned parameter \hat{ }Θ (step S109).

<Flow of Test Processing>

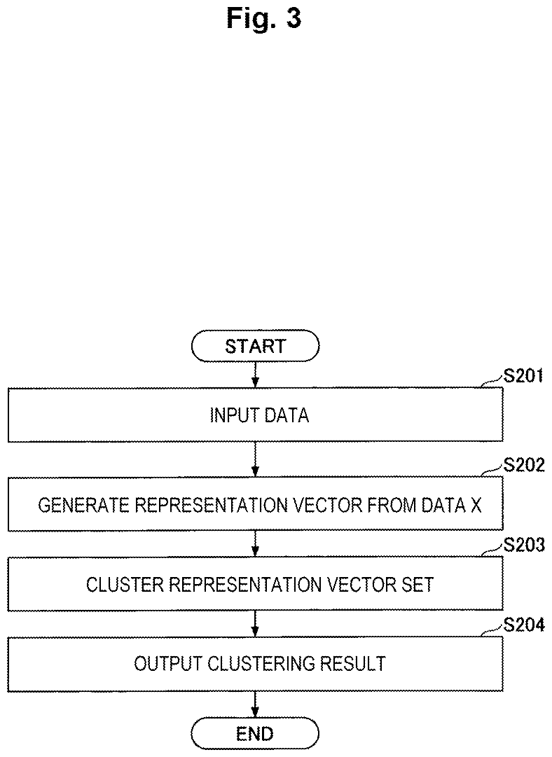

A flow of test processing according to the present embodiment will be described with reference to FIG. 3 hereinbelow. FIG. 3 is a flowchart illustrating one example of the flow of test processing according to the present embodiment.

First, the input unit 101 inputs the unlabeled data X={xₙ} to be clustered from the storage unit 107 as the input data (step S201). Note that, for the sake of simplicity, the number of items of case data included in the input data X is assumed to be N hereinbelow.

Next, the representation conversion unit 102 generates a representation vector zₙ from the case data x; included in the input data X input in step S201 stated above (step S202). Note that the representation conversion unit 102 can generate the representation vector zₙ by converting the case data xₙ using Formula (1) stated above. In addition, the learned parameter \hat{ }Θ is used as the parameter of the neural network f in Formula (1) stated above.

Next, the clustering unit 103 clusters a set of representation vectors {z₁, . . . , z_{N}} generated in step S202 stated above, and estimates the contribution rate R as the clustering result (step S203). Note that the clustering unit 103 may perform clustering and estimation of the contribution rate R by steps S1 to S4 stated above.

Then, the output unit 106 outputs the contribution rate R as the clustering result in step S203 stated above (step S204). Note that although the contribution rate R is taken as the clustering result in the present embodiment, for example, information indicating a belonging relationship for each item of case data xₙ which is determined with reference to the contribution rate R (that is, information indicating to which cluster each item of case data xₙ belongs (including a case where each item of case data xₙ does not belong to any cluster and a case where each item of case data xₙ belongs to two or more clusters at the same time)) may be taken as the clustering result.

<Evaluation>

Evaluation of the clustering method (hereinafter referred to as the “proposed method”) by the clustering apparatus 10 according to the present embodiment will be described. For evaluating the proposed method, clustering is performed using anomaly detection data, and the result was compared with existing methods. In addition, the adjusted Rand index is used as a clustering evaluation scale. Comparison results are summarized in the following Table 1:

TABLE 1

| Proposed method | GMN | AE + GMM |
|---|---|---|
| 0.912 | 0.882 | 0.866 |

where GMM in Table 1 represents a clustering method using an infinite mixture Gaussian distribution, and AE+GMM represents a clustering method in which a self-encoder and the infinite mixture Gaussian distribution are combined.

As shown in Table 1 above, it can be seen that the proposed method achieves a higher adjusted Rand index as compared to the existing method. Therefore, high-performance clustering can be implemented by the proposed method.

<Hardware Configuration>

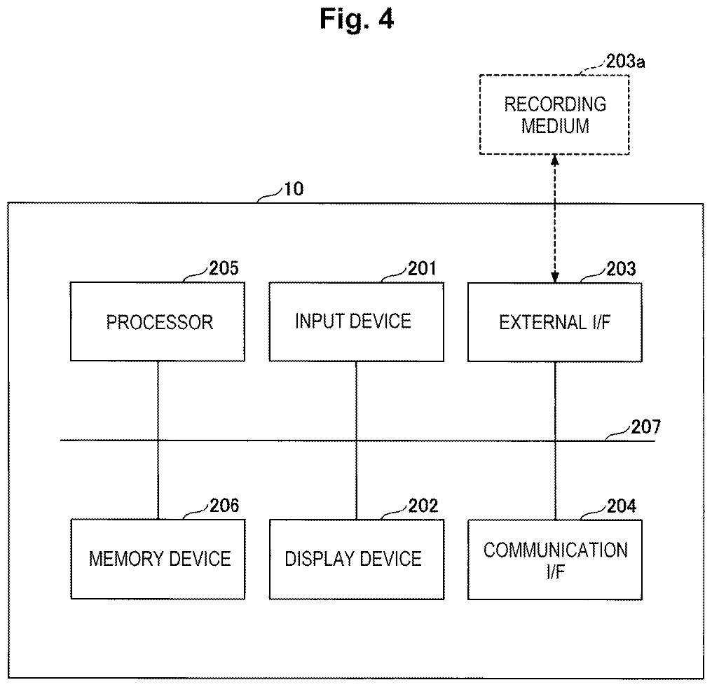

Finally, a hardware configuration of the clustering apparatus 10 according to the present embodiment will be described with reference to FIG. 4. FIG. 4 is a diagram illustrating one example of a hardware configuration of the clustering apparatus 10 according to the present embodiment.

As illustrated in FIG. 4, the clustering apparatus 10 according to the present embodiment is implemented by a hardware configuration of a general computer or a computer system, which includes an input device 201, a display device 202, an external I/F 203, a communication I/F 204, a processor 205, and a memory device 206. These hardware components are communicably connected via a bus 207.

The input device 201 is, for example, a keyboard, a mouse, a touchscreen, or the like. The display device 202 is, for example, a display or the like. The clustering apparatus 10 may not include, for example, at least one of the input device 201 and the display device 202.

The external I/F 203 is an interface with an external device such as a recording medium 203a. The clustering apparatus 10 can execute, for example, reads and writes on the recording medium 203a via the external I/F 203. For example, one or more programs for implementing the functional units (the input unit 101, the representation conversion unit 102, the clustering unit 103, the evaluation unit 104, the learning unit 105, and the output unit 106) included in the clustering apparatus 10 may be stored in the recording medium 203a.

Note that the recording medium 203a is, for example, a compact disc (CD), a digital versatile disk (DVD), a secure digital memory card (SD memory card), a universal serial bus (USB) memory card, or the like.

The communication I/F 204 is an interface for connecting the clustering apparatus 10 to a communication network. Note that the one or more programs for implementing the functional units included in the clustering apparatus 10 may be acquired (downloaded) from, for example, a predetermined server device via the communication I/F 204.

The processor 205 is, for example, an arithmetic/logic device of various types such as a central processing unit (CPU) and a graphics processing unit (GPU). The functional units included in the clustering apparatus 10 are implemented, for example, by processing in which the one or more programs stored in the memory device 206 are executed by the processor 205.

The memory device 206 is, for example, a storage device, such as a hard disk drive (HDD), a solid state drive (SSD), a random access memory (RAM), a read-only memory (ROM), and a flash memory. The storage unit 107 included in the clustering apparatus 10 can be implemented, for example, using the memory device 206. Note that the storage unit 107 may be implemented using, for example, a storage device connected to the clustering apparatus 10 via the communication network.

The clustering apparatus 10 according to the present embodiment can implement the learning processing and the test processing by having the hardware configuration illustrated in FIG. 4. Note that the hardware configuration illustrated in FIG. 4 is merely an example, and the clustering apparatus 10 may have another hardware configuration. For example, the clustering apparatus 10 may include a plurality of processors 205 or a plurality of memory devices 206.

The present invention is not limited to the embodiments stated above, and various modification, changes, and combinations with known techniques can be made without departing from the scope of the claims.

### REFERENCE SIGNS LIST

10 Clustering apparatus
101 Input unit
102 Representation conversion unit
103 Clustering unit
104 Evaluation unit
105 Learning unit
106 Output unit
107 Storage unit
201 Input device
202 Display device
203 External I/F
203a Recording medium
204 Communication I/F
205 Processor
206 Memory device
207 Bus

1. A learning method, executed by a computer including a memory and a processor, the method comprising:
inputting a plurality of items of data, and a plurality of labels representing clusters to which the plurality of items of data belong;
converting each of the plurality of items of data by a predetermined neural network, to generate a plurality of items of representation data;
clustering the plurality of items of representation data;
calculating a predetermined evaluation scale indicating performance of the clustering, based on the clustering result and the plurality of labels; and
learning a parameter of the neural network, based on the evaluation scale.

2. The learning method according to claim 1, wherein the converting converts each of the plurality of items of data and data representing a representation of a predetermined target task by the neural network, to generate the plurality of items of representation data.

3. The learning method according to claim 1, wherein the clustering performs clustering by estimating a contribution rate indicating a probability that each of the plurality of items of representation data belongs to each of the plurality of clusters, and
the calculating calculates the evaluation scale, by using the contribution rate as the clustering result.

4. A clustering method, executed by a computer including a memory and a processor, the method comprising:
inputting a plurality of items of data;
converting each of the plurality of items of data by a predetermined neural network in which a parameter trained in advance is set, to generate a plurality of items of representation data; and
clustering the plurality of items of representation data.

5. A learning apparatus comprising:
a memory and a processor configured to input a plurality of items of data and a plurality of labels representing clusters to which the plurality of items of data belongs;
convert each of the plurality of items of data by a predetermined neural network, to generate a plurality of items of representation data;
cluster the plurality of items of representation data;
calculate a predetermined evaluation scale indicating performance of the clustering based on the clustering result and the plurality of labels; and
learn a parameter of the neural network, based on the evaluation scale.

6. (canceled)

7. A non-transitory computer-readable recording medium having computer-readable instructions stored thereon, which when executed, cause a computer to execute the learning method as set forth in claim 1.

8. A non-transitory computer-readable recording medium having computer-readable instructions stored thereon, which when executed, cause a computer to execute the clustering method as set forth in claim 4.
